(19) United States
(12) Patent Application Publication
(10) Pub. No.: US 2009/0319166 A1
(43) Pub. Date: Dec. 24, 2009

(54) MOBILE COMPUTING SERVICES BASED ON DEVICES WITH DYNAMIC DIRECTION INFORMATION

(75) Inventors: Moe Khosravy, Bellevue, WA (US); Lev Novik, Bellevue, WA (US); Irena Hudis, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/364,936

(22) Filed: Feb. 3, 2009

Related U.S. Application Data
(60) Provisional application No. 61/074,415, filed on Jun. 20, 2008.

(51) Int. Cl. G01C 21/26; G06Q 30/00

(52) U.S. Cl. 701/200; 705/1; 705/14.3

(57) ABSTRACT

Direction based pointing services are enabled for a portable electronic device including a positional component for receiving positional information as a function of a location of the portable electronic device, a directional component that outputs direction information as a function of an orientation of the portable electronic device and a location based engine that processes the positional information and the direction information to determine points of interest relative to the portable electronic device as a function of at least the positional information and the direction information. A set of scenarios with respect to non-movable endpoints of interest in the system emerge and these scenarios and other embodiments are described in more detail below.

### CROSS-REFERENCE TO RELATED APPLICATIONS

This application claims priority to U.S. Provisional Application Ser. No. 61/074,415, filed on Jun. 20, 2008 entitled “MOBILE COMPUTING SERVICES BASED ON DEVICES WITH DYNAMIC DIRECTION INFORMATION”, the entirety of which is incorporated herein by reference.

### TECHNICAL FIELD

The subject disclosure relates to devices, services, applications, architectures, user interfaces and scenarios for mobile computing devices based on dynamic direction information associated with a portable computing device.

### BACKGROUND

By way of background concerning some conventional systems, mobile devices, such as portable laptops, PDAs, mobile phones, navigation devices, and the like have been equipped with location based services, such as global positioning system (GPS) systems, WiFi, cell tower triangulation, etc. that can determine and record a position of mobile devices. For instance, GPS systems use triangulation of signals received from various satellites placed in orbit around Earth to determine device position. A variety of map-based services have emerged from the inclusion of such location based systems that help users of these devices to be found on a map and to facilitate point to point navigation in real-time and search for locations near a point on a map.

However, such navigation and search scenarios are currently limited to displaying relatively static information about endpoints and navigation routes. While some of these devices with location based navigation or search capabilities allow update of the bulk data representing endpoint information via a network, e.g., when connected to a networked portable computer (PC) or laptop, such data again becomes fixed in time. Accordingly, it would be desirable to provide a set of pointing-based or directional-based services that enable a richer experience for users than conventional experiences predicated on location and conventional processing of static bulk data representing potential endpoints of interest.

The above-described deficiencies of today's location based systems, devices and services are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various embodiments, direction based pointing services are enabled for a portable electronic device including a positional component for receiving positional information as a function of a location of the portable electronic device, a directional component that outputs direction information as a function of an orientation of the portable electronic device and a location based engine that processes the positional information and the direction information to determine points of interest relative to the portable electronic device as a function of at least the positional information and the direction information. A set of scenarios with respect to non-movable endpoints of interest in the system emerge and these scenarios and other embodiments are described in more detail below.

### BRIEF DESCRIPTION OF THE DRAWINGS

Various non-limiting embodiments are further described with reference to the accompanying drawings in which:

FIG. 1 is an exemplary non-limiting flow diagram of an intersection process for performing direction based services with respect to potential points of interest;

FIG. 2 is a block diagram illustrating exemplary formation of motion vectors for use in connection with directional based services and scenarios;

FIG. 3 represents a generic UI for displaying a set of points of interest to a user based on pointing based services;

FIG. 4 is a flow diagram illustrating a non-limiting point and discover scenario;

FIG. 5 represents some exemplary, non-limiting fields or user interface windows for displaying static and dynamic information about a given point of interest;

FIG. 6 is a flow diagram illustrating a non-limiting point and search scenario;

FIG. 7 illustrates a generalized non-limiting intersection algorithm that can be applied to point and discover/search scenarios;

FIG. 8 is a flow diagram illustrating a non-limiting point scenario that dynamically defines the scope of search/filtering for the pointing process;

FIG. 9 is a block diagram illustrating a targeted advertising embodiment of the pointing based services;

FIG. 10 is a flow diagram illustrating a non-limiting dynamically targeted advertising scenario;

FIG. 11 is a flow diagram illustrating a non-limiting dynamically business intelligence and reporting scenario;

FIG. 12 is a block diagram illustrating a business intelligence and reporting scenario for pointing based services;

FIG. 13 is a flow diagram illustrating a non-limiting intelligent process for dynamically setting a scope of points of interest for a pointing scenario;

FIG. 14 is a flow diagram illustrating a navigation system predicated on actual user path and time data as enabled by the pointing based services;

FIG. 15 is a block diagram of a discovery or search for real estate as a point of interest along a direction pointed at by a user;

FIG. 16 is a flow diagram of a scenario where a user delays interaction with a point of interest;

FIG. 17 illustrates a block diagram of a non-limiting device architecture for pointing based services;

FIG. 18 is a block diagram representing an exemplary non-limiting networked environment in which embodiment(s) may be implemented; and

FIG. 19 is a block diagram representing an exemplary non-limiting computing system or operating environment in which aspects of embodiment(s) may be implemented.

### DETAILED DESCRIPTION

### Overview

As discussed in the background, among other things, current location services systems and services, e.g., GPS, cell triangulation, P2P location service, such as Bluetooth, WiFi, etc., tend to be based on the location of the device only, and tend to provide static experiences that are not tailored to a user because the data about endpoints of interest is relatively static. At least partly in consideration of these deficiencies of conventional location based services, various scenarios based on pointing capabilities for a portable device are provided that enable users to point a device directionally and receive static and/or dynamic information in response from a networked service, such as provided by one or more servers, or as part of a cloud services experience, with respect to one or more fixed endpoints in the system.

In one non-limiting aspect, users can interact with the endpoints in a host of context sensitive ways to provide or update information associated with endpoints of interest, or to receive beneficial information or instruments from entities associated with the endpoints of interest. For instance, a set of scenarios are considered herein based on non-mobile or non-movable endpoints in such a system from the perspective a mobile device that moves across geographical regions as the holder/user of the device moves across geographical regions. A variety of user interfaces can be provided to correspond to such scenarios as well.

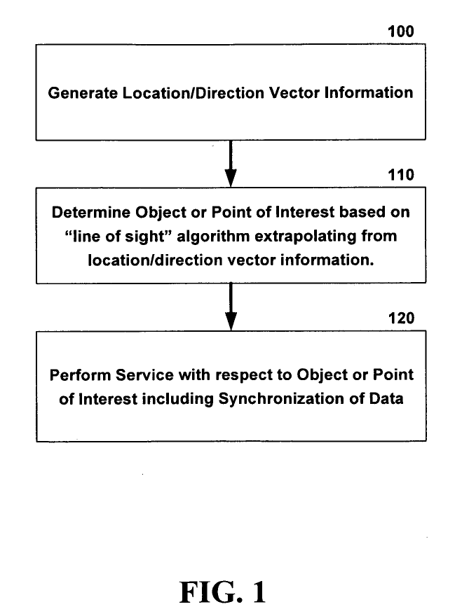

A representative interaction with a set of endpoints by a pointing device as provided in one or more embodiments herein is illustrated via the flow chart of FIG. 1. At 100, location/direction vector information is determined based on the device measurements. This information can be recorded so that a path or past of a user can be taken into account when predictively factoring where the device will be or what the user will be interested in next, e.g., to keep point of interest data in a local cache up to date. This information can also be reported to the network service as part of aggregate business intelligence, upon which further scenarios can be based as described below in more detail.

In various embodiments, algorithms are applied to direction information to define a scope of objects of interest for a device, such as a set of objects displayed within a bounding box or bounding curve shown the display of the device. For instance, ray tracing can be used to define a scope of objects within a certain angle or distance from a device. While in some embodiments, a compass can conveniently provide direction information, a compass is optional. In this regard, any collision detection method can be used to define a set of objects of interest for the device, e.g., for display and interaction from a user. For instance, a bounding curve such as a bounding box, or sphere, of a user intersecting can be used as a basis to display points of interest, such as people, places, and things near the user. As another alternative, location information can be used to infer direction information about the device.

Next, based on the vector information, or more informally, the act of pointing by the user, at 110, an object or point of interest, or set of them, is determined based on any of a variety of “line of sight,” boundary overlap, conical intersection, etc. algorithms that fall within or outside of the vector path. It is noted that occlusion culling techniques can optionally be used to facilitate any overlay techniques. Whether the point of interest at issue falls within the vector path can factor in the error in precision of any of the measurements, e.g., different GPS subsystems have different error in precision.

In this regard, as a result of such an intersection test, one or more fixed items or non-movable points of interest may be found along the vector path or arc, within a certain distance depending on context. The list can be further narrowed based on the user profile, the context of the service, etc. At 120, a variety of services can be performed with respect to one or more points of interest selected by the user via a user interface. Where only one point of interest is concerned, one or more services can be automatically performed with respect to the point of interest, again depending on context.

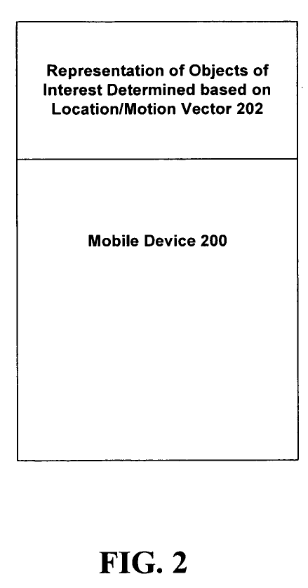

As shown in FIG. 2, once a set of objects is determined from the pointing information according to a variety of contexts of a variety of services, a mobile device 200 can display the objects via representation 202 according to a variety of user experiences tailored to the service at issue. For instance, a virtual camera experience can be provided, where POI graphics or information can be positioned relative to one another to simulate an imaging experience. A variety of other user interface experiences can be provided based on the pointing direction, where the points of interest determined by the act of pointing are represented on screen via a user interface representation 202 suited for the scenario or service.

Based on a device having pointing capabilities that can define a direction motion vector for the device, as described herein, a broad range of scenarios can be enabled where web services effectively resolve vector coordinates sent from mobile endpoints into <x, y, z> or other coordinates using location data, such as GPS data, as well as configurable, synchronized POV information similar to that found in a GPS system in an automobile. In this regard, any of the embodiments can similarly be applied in any motor vehicle device. As described in more detail below, one non-limiting use is also facilitation of endpoint discovery for synchronization of data of interest to or from the user from or to the endpoint.

In a non-limiting implementation of a pointing device, an accelerometer is used in coordination with an on board digital compass, and an application running on the device updates what each endpoint is “looking at” or pointed towards, attempting hit detection on potential points of interest to either produce real-time information for the device or to allow the user to select a range. Or, using the GPS system, a location on a map can be designated on a map, and a set of information provided to the user about various endpoints, such as “Starbucks—10% off cappuccinos today” or “The Alamo—site of . . . ” for others to discover. One or more accelerometers can also be used to perform the function of determining direction information for each endpoint as well.

Accordingly, a general device for accomplishing this includes assets to resolve a line of sight vector sent from a mobile endpoint and a system to aggregate that data as a platform, enabling a host of new scenarios predicated on the pointing information known for the device. In this regard, the pointing information and corresponding algorithms ultimately depend upon the precision of the assets available in a device for producing the pointing information. The pointing information, however produced according to an underlying set of measurement components, and interpreted by an engine, can be one or more vectors. A vector or set of vectors can have a “width” or “arc” associated with the vector for any margin of error associated with the pointing of the device. A panning angle can be defined by a user with at least two pointing actions to encompass a set of points of interest, e.g., those that span a certain angle defined by a panning gesture by the user.

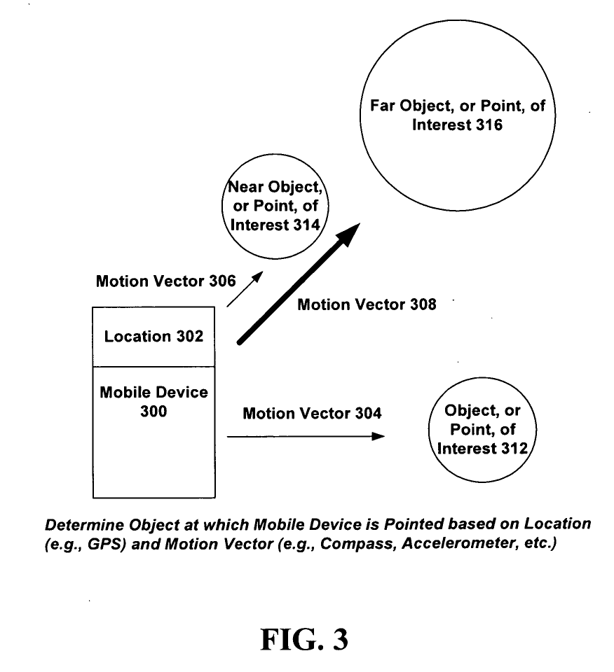

An exemplary, non-limiting algorithm for interpreting position/motion/direction information is shown in FIG. 3. A device 300 employing direction based location based services 302 in a variety of embodiments herein includes a way to discern between near objects, such as POI 314 and far objects, such as POI 316. Depending on the context of usage, the time, the user's past, the device state, the speed of the device, the nature of the POIs, etc., the service can determine a general distance associated with a motion vector. Thus, in the example, a motion vector 306 will implicate POI 314, but not POI 316, and the opposite would be true for motion vector 308.

In addition, a device 300 includes an algorithm for discerning items substantially along a direction at which the device is pointing, and those not substantially along a direction at which the device is pointing. In this respect, while motion vector 304 might implicate POI 312, without a specific panning gesture that encompassed more directions/vectors, POIs 314 and 316 would likely not be within the scope of points of interest defined by motion vector 304. The distance or reach of a vector can also be tuned by a user, e.g., via a slider control or other control, to quickly expand or contract the scope of endpoints encompassed by a given “pointing” interaction with the device.

In one non-limiting embodiment, the determination of at what or whom the user is pointing is performed by calculating an absolute “Look” vector, within a suitable margin of error, by a reading from an accelerometer's tilt and a reading from the magnetic compass. Then, an intersection of endpoints determines an initial scope, which can be further refined depending on the particular service employed, i.e., any additional filter. For instance, for an apartment search service, endpoints falling within the look vector that are not apartments ready for lease, can be pre-filtered.

In addition to the look vector determination, the engine can also compensate for, or begin the look vector, where the user is by establish positioning (˜15 feet) through an A-GPS stack (or other location based or GPS subsystem including those with assistance strategies) and also compensate for any significant movement/acceleration of the device, where such information is available.

One non-limiting way for achieving this is to define an arc or an area within an arc and a corresponding distance that encompasses certain POI, but does not encompass other POIs. Such an algorithm determines edge case POIs where they partially fall within the area defined by the arc and distance. For another non-limiting example, with location information and direction information, a user can input a first direction via a click, and then a second direction after moving the device via a second click, which in effect defines an arc. The area of interest implicitly includes a search of points of object within a distance, which can be zoomed in and out, or selected by the service based on a known granularity of interest, selected by the user, etc. This can be accomplished with a variety of forms of input to define the two directions. For instance, the first direction can be defined upon a click-and-hold button event, or other engage-and-hold user interface element, and the second direction can be defined upon release of the button. Similarly, two consecutive clicks corresponding to the two different directions and can also be implemented. In effect, this technique defines a panning motion across a set of endpoints. This could be further enhanced by usage of a differential GPS solution to obtain more accuracy.

A gesture subsystem can also be included in a device. In this regard, one can appreciate that a variety of algorithms could be adopted for a gesture subsystem. For instance, a simple click-event when in the “pointing mode” for the device can result in determining a set of points of interest for the user. Other gestures can indicate a zoom in or zoom out operation, and so on.

Other gestures that can be of interest in for a gesturing subsystem include recognizing a user's gesture for zoom in or zoom out. Zoom in/zoom out can be done in terms of distance. Also, instead of focusing on real distance, zooming in or out could also represent a change in terms of granularity, or size, or hierarchy of objects. For example, a first pointing gesture with the device may result in a shopping mall appearing, but with another gesture, a user could carry out a recognizable gesture to gain or lose a level of hierarchical granularity with the points of interest on display. For instance, after such gesture, the points of interest could be zoomed in to the level of the stores at the shopping mall and what they are currently offering.

In addition, a variety of even richer behaviors and gestures can be recognized when acceleration of the device in various axes can be discerned. Panning, arm extension/retraction, swirling of the device, backhand tennis swings, breaststroke arm action, golf swing motions could all signify something unique in terms of the behavior of the pointing device, and this is to name just a few motions that could be implemented in practice. Thus, any of the embodiments herein can define a set of gestures that serve to help the user interact with a set of services built on the pointing platform, to help users easily gain information about points of information in their environment.

Furthermore, with relatively accurate upward and downward tilt of the device, in addition to directional information such as calibrated and compensated heading/directionality information, other services can be enabled. Typically, if a device is ground level, the user is outside, and the device is “pointed” up towards the top of buildings, the granularity of information about points of interest sought by the user (building level) is different than if the user was pointing at the first floor shops of the building (shops level), even where the same compass direction is implicated. Similarly, where a user is at the top of a landmark such as the Empire State building, a downward tilt at the street level (street level granularity) would implicate information about different points of interest that if the user of the device pointed with relatively no tilt at the Statue of Liberty (landmark/building level of granularity).

Also, when a device is moving in a car, it may appear that direction is changing as the user maintains a pointing action on a single location, but the user is still pointing at the same non-movable object—the angle change is merely due to displacement of the device. Thus, time varying location can be factored into the mathematics and engine of resolving at what the user is pointing with the device to compensate for the user experience based upon which all items are relative.

Accordingly, armed with the device's position, one or more web or cloud services can analyze the vector information to determine at what or whom the user is looking/pointing as well as services that tell the user about the location of other users, e.g., perhaps on other services like MySpace, Match, Facebook, etc. The service can then provide additional information such as ads, specials, updates, menus, happy hour choices, etc., depending on the endpoint selected, the context of the service, the location (urban or rural), the time (night or day), etc. As a result, instead of a blank contextless Internet search, a form of real-time visual search for users in real 3-D environments is provided.

The act of pointing with a device, such as the user's mobile phone, thus becomes a powerful vehicle for users to discover and interact with points of interest around the individual in a way that is tailored for the individual. Synchronization of data can also be performed to facilitate roaming and sharing of POI data and contacts among different users of the same service.

In a variety of embodiments described herein, 2-dimensional (2D), 3-dimensional (3D) or N-dimensional directional-based search, discovery, and interactivity services are enabled for endpoints in the system of potential interest to the user. one scenario includes pointing to a building, using the device's GPS, accelerometer, and digital compass to discover the vector formed by the device and the POI location to which the user is pointing. If no information exists, the user can enter information about the object or location, which can be synchronized to the applicable service.

Another exemplary, non-limiting scenario includes point and click synchronization where, for instance, a web service and application allow users to point and sync contacts, files, media, etc. by simply locating another endpoint using line of sight. Synchronization can occur through the cloud or directly via WIFI/BlueTooth, etc.

In one non-limiting embodiment, the direction based pointing services are implemented in connection with a pair of glasses, headband, etc. having a corresponding display means that acts in concert with the user's looking to highlight or overlay features of interest around the user.

While each of the various embodiments below are presented independently, e.g., as part of the sequence of respective Figures, one can appreciate that an integrated handset, as described, can incorporate or combine two or more of any of the embodiments. Given that each of the various embodiments improve the overall services ecosystem in which users wish to operate, together a synergy results from combining different benefits when a critical user adoption mass is reached. Specifically, when a direction based pointing services platform provides the cross benefits of different advantages, features or aspects of the various embodiments described herein, users are more likely to use such a beneficial platform. As a generally recognized relationship, the more likely users will be to use, the more the platform gains critical mass according to the so-called network effect of adoption. Any one feature or service standing alone may or may not gain such critical mass, and accordingly, the combination of different embodiments described below shall be considered herein to represent a host of further alternate embodiments.

Details of various other exemplary, non-limiting embodiments and scenarios predicated on portable pointing devices are provided below.

### Pointing Device Scenarios for Non-Movable Points of Interest

As mentioned, a variety of scenarios are described herein for pointing based location services for mobile devices with respect to relatively stationary endpoints. With A-GPS or other GPS subsystems and accelerometers together with a magnetic compass, mobile devices, such as phones, can easily answer a variety of questions simply by pointing with the device. For instance, in retail/merchandising scenarios, a user can quickly point to the store and discover “What does that restaurant serve? Are they running any specials today?” Or “I wonder if that store is open and what their hours are . . . ” Or “Does that house for sale across the street have a spa or a pool?” Or “All the signs here in Japan are in Japanese—is localized info available for shopping here so that I can read these signs in English too?”

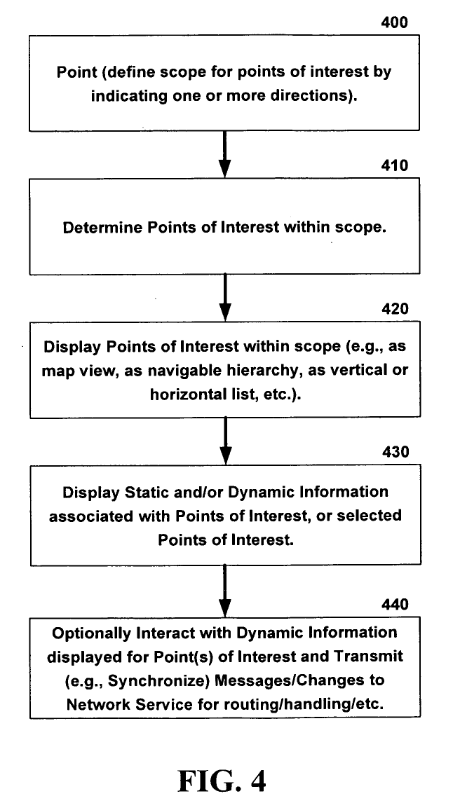

In this regard, a mobile device with pointing capabilities can be operated in an information discovery mode in which the user of the device is walking, turning, driving, etc. and pointing to points of interest (buildings, landmarks, etc. as well as other users) to get information as well as to interact with them. In effect, the user possesses a magic wand to aim at objects, things, points of interest, etc. and get/set get/set information with the click of a button, or other activation of the service. FIG. 4 is a flow diagram of a non-limiting process for achieving a point and discover scenario.

At 400, the device is pointed in one or more directions, and according to one or more gestures, depending on device capabilities, thereby defining the scope for points of interest by indicating one or more directions. At 410, based on motion vectors determined for the pointing, a service determines current points of interest within scope. At 420, points of interest within scope are displayed, e.g., as map view, as navigable hierarchy, as vertical or horizontal list, etc. At 430, static and/or dynamic information associated with the points of interest, or selected points of interest, is displayed. The points of interest data and associated information can be pre-fetched to a local cache for seamless processing of point and discover inquiries. For selecting points of interest, various user interfaces can be considered such as left-right, or up-down arrangements for navigating categories, or a special set of soft-keys can be adaptively provided, etc. At 440, the user can optionally interact with dynamic information displayed for point(s) of interest and such changes/message can be transmitted (e.g., synchronized) to network storage for further routing/handling/etc.

A sample use of the point and discover scenario from the perspective of a user of a pointing device can be: “I just moved nearby to this location, but do not know much about my surroundings. I will point my device down this street and discover what points of interest generally are discoverable, and then learning about a historic landmark nearby as part of navigating the result list.” Another example is a scenario of a museum tour, where a user is on his or her own to discover great works of art and associated information about the points of interest, and add to the wealth of knowledge, where appropriate, without the need for a tour guide.

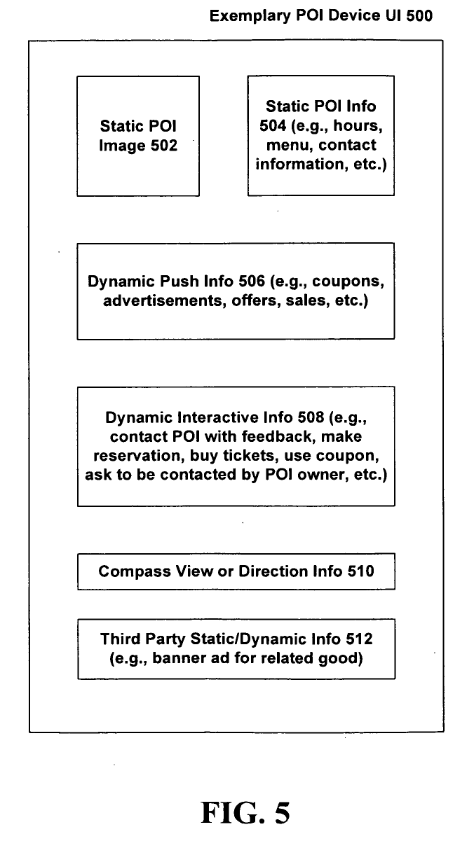

Once a particular point of interest is identified by the user explicitly or implicitly as a point of interest the user wants to know more about, the particular point of interest can be displayed on the device in a more detailed format, such as the format shown in the representative UI of FIG. 5 illustrating a full screen view via exemplary non-limiting UI 500.

UI 500 of FIG. 5 can have one or more of any of the following representative areas. UI 500 can include a static POI image 502 such as a trademark of a store, or a picture of a person. UI 500 can also include other media, and a static POI information portion 504 for information that tends not to change such as restaurant hours, menu, contact information, etc. In addition, UI 500 can include an information section for dynamic information to be pushed to the user for the POI, e.g., coupons, advertisements, offers, sales, etc. In addition, a dynamic interactive information are 508 can be included where the user can fill out a survey, provide feedback to the POI owner, request the POI to contact the user, make a reservation, buy tickets, etc. UI 500 also can include a representation of the direction information output by the compass for reference purposes. Further, UI 500 can include other third party static or dynamic content in area 512. Thus, there are a variety of ways to interact with the content of a discovered point of interest.

When things change from the perspective of either the service or the client, a synchronization process can bring either the client or service, respectively, up to date. In this way, an ecosystem is enabled where a user can point at an object or point of interest, gain information about it that is likely to be relevant to the user, interact with the information concerning the point of interest, and add value to services ecosystem where the user interacts. The system thus advantageously supports both static and dynamic content.

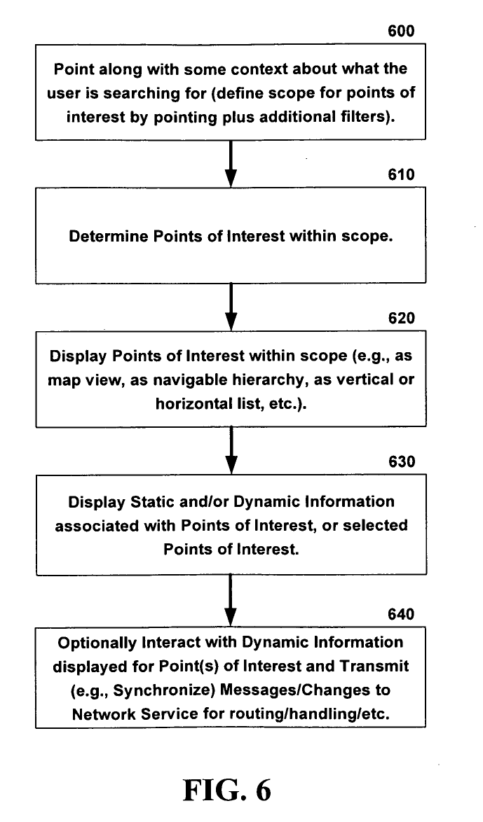

In this respect, a scenario is enabled where a user merely points with the device and discovers points of interest and information of interest in the process. Taking the scenario a step further, pointing can also be in effect a form of querying of the service for points of interest, thereby providing a point and search experience. FIG. 6 is a flow diagram of a non-limiting process for achieving a point and search scenario.

At 600, a user points a device along with some context about what the user is searching for, either explicitly (e.g., defining search terms) or implicitly (e.g., “Use of a Restaurant Finder Service” to define scope for points of interest along the pointing direction plus any additional filters represented by the search context. At 610, based on motion vectors determined for the pointing, a service determines current points of interest within scope. At 620, points of interest within scope are displayed, e.g., as map view, as navigable hierarchy, as vertical or horizontal list, etc. At 630, static and/or dynamic information associated with the points of interest, or selected points of interest, is displayed. The points of interest data and associated information can be pre-fetched to a local cache for seamless processing of point and discover inquiries. For selecting points of interest, various user interfaces can be considered such as left-right, or up-down arrangements for navigating categories, or a special set of soft-keys can be adaptively provided, etc. At 640, the user can optionally interact with dynamic information displayed for point(s) of interest and such changes/message can be transmitted (e.g., synchronized) to network storage for further routing/handling/etc.

The point and search scenario could apply to treasure hunts, such as Easter egg hunts, where clues lead a point and searcher successively closer to a goal. The point and search scenario could help a user find a coffee shop or restaurants or other category of points of interest in a particular area. The point and search scenario can be applied to gaming, such as a simulation of bow-and-arrow shooting at a set of arbitrary targets set up in one's yard (e.g., a knot on a tree, a window, a log, etc.) such that the user “points” with a shooting gesture at the pre-filtered list of targets of interest.

In this regard, scenario based filtering implicates a lot of different ways to filter a potential set of points of interest especially in crowded spaces of points of interest where a user will desire to filter through a lot of noise that is not relevant to the user, which is uncovered during the generalized point and discover scenario.

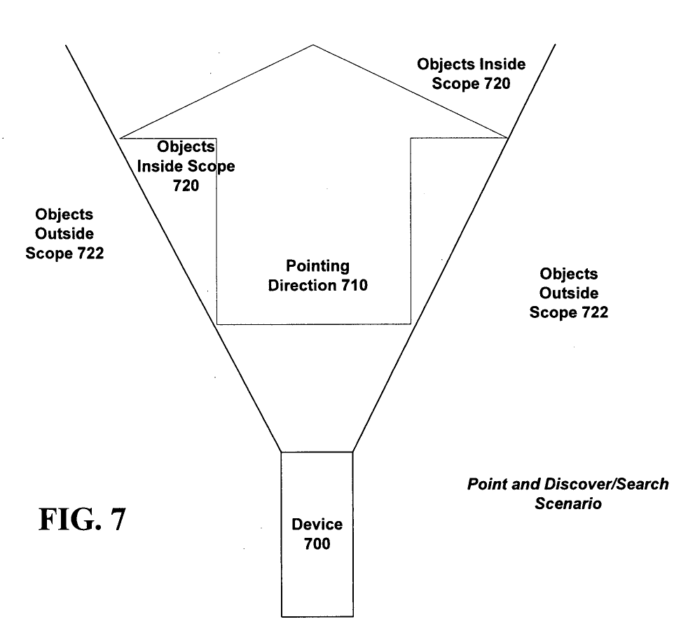

For instance, as illustrated in FIG. 7, for a point and discover or search scenario, a device 700 points according to one or more directions 710 (one direction shown for simplicity) to define a scope of objects. Objects 720 are then inside the scope and objects 722 are outside the scope.

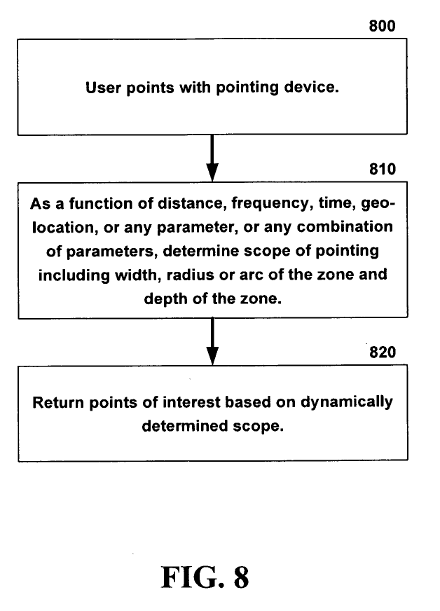

Also, as described in FIG. 8, a process for dynamically defining a region of interest based on a pointing direction is described. At 800, a user points with pointing device. At 810, as a function of distance, frequency, time, geo-location, or any parameter, or any combination of parameters, the scope of pointing including width, radius or arc of the zone and depth of the zone are determined. At 820, points of interest based on dynamically determined scope are returned to the device.

As a representative use of this dynamic scope determination, if a user is pointing at downtown Seattle from across Lake Washington, the service, not encountering any points of interest in the lake itself, can be smart enough to determine that the scope of search should be deep to capture the skyline of Seattle. In this regard, the scope of search may fan out by 30 degrees to capture the entire skyline. One proxy for such dynamic scope would be to determine an average distance of a set of points of interest in a particular direction, and then to tune the scope to where hits are most likely. Thus, if the user is pointing at point(s) of interest from far out, a fan out region can be defined. Similarly, if a user selects a mall as a point of interest from across the street, the service can dynamically select a new region for search that provides a fan out of the sub-stores of the mall.

Another way to dynamically define a search zone is by the action of pointing itself. For instance, if a device has an accelerometer, then it can understand a panning operation intuitively. If a user points and pans across a horizon of a landscape, the results can be returned via a horizontal pan. If the user points and pans up and down a building, the results can be returned for a vertical pan, e.g., for a skyscraper scan of its floors.

In addition, once presented with the results based on a given scope of points of interest, a user can decide to drill in and/or drill out, e.g., in terms of distance, width or height of search zone, size of objects, etc. If a user is literally standing right in front of only 1 point of interest, such as the Statue of Liberty, then the device can be smart enough and directly show the content for it without going to shore to display further points of interest. Examples of static information that can be set by an owner of information about a point of interest include name, address, hours, URL, other static and/or dynamic content (which can be updated in real time via synchronization). Examples of dynamic content could be what the main exhibits are at a museum, whether the museum is empty or really crowded, or whether a show is sold out, such that if there are too many people, people can come back the next day. Other examples include coupons, advertisements, sale information, offers, deals, etc.

Moreover, whenever a “trigger” occurs for a given point of interest or set of points of interest, audio and/or visual notifications can be rendered. In this regard, a trigger can occur upon the satisfaction of any condition(s) with respect to a given point of interest. For instance, a trigger can occur when a device nears a point of interest of a filtered set of points of interest, a trigger can occur when an offer is available from a store, a trigger can occur when a reminder was set for the point of interest, a trigger can occur when a user is near a movie theatre where a pre-specified movie of interest is playing, and so on.

Another exemplary scenario can be based on point and track to monitor delivery progress of Fed ex items, or pizza, and also for asset recovery. With respect to a pizza delivery, on the box, or on a reusable heat trapper for keeping pizza warm, a pointing device can be attached such that in a “pizza tracking” mode, a user could point, and see where the pizza is currently. In an alternate embodiment, a bar code can be printed on a pizza box, and as it leaves the front door of the pizza store, data about its departure time becomes available about the designated point of interest (here the pizza). Similarly, if an asset is stolen, the pointing information for the asset can be used to recover the asset by following its path. A device could be embedded in the frames of expensive paintings, for instance.

With respect to a point and educate scenario for points of interest, this scenario presents a sort of mobile Wikipedia for points of interest. For instance, “What kinds of “wikipedia” facts have people entered about this statue, lake, etc?” If the user wishes, the user can add to the Wikipedia of knowledge about the stature, lake, etc. including upload of photographs and the like, to share with other specific users, e.g., a group of friends, or to all other users of the pointing services. This scenario is sure to displace conventional messy T9 typing or bad voice activated search to find out information on local businesses, points of interest, or information on display such as those in a museum or on a tour.

As mentioned in steps 440 and 640 of FIGS. 4 and 6, respectively, a user can optionally interact with dynamic information displayed for point(s) of interest and such changes/message can be transmitted (e.g., synchronized) to network storage for further routing/handling/etc. In effect, this is a point and add to knowledge pool scenario, e.g., a location based search where users update information for others to discover by subsequent pointing acts. Examples of information that can be updated dynamically are user reviews, or where some information in the possession of the user is missing, the user adds the information to the benefit of all others. A mobile wiki experience can thus be enabled for each point of interest in the system. For an enterprise scenario, such as an experience inside a Starbucks or Best Buy, in one embodiment, advertisements or other information can be directly injected into information that the user is interacting with inside the store, e.g., highlighting certain sale items based on information about the user.

For another non-limiting scenario, at a waterfall in an obscure national park, if no one has before added information for that waterfall, the user can add some photos. Geo-tagging of photos facilitates the automatic assignment of such photos to the appropriate points of interest. Similarly, a mobile digg scenario is enabled where the user can proclaim that “this is a great restaurant.” Or, the user can retrieve zagat ratings for a restaurant and augment them with the user's personal notes. The notes can be private, shared with the owner of the point of interest, or shared back into the network service for viewing by all.

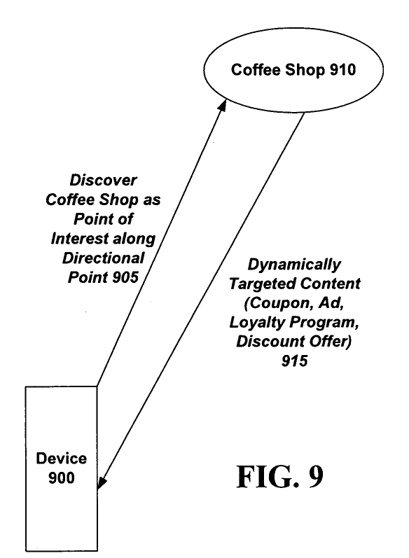

Advertising scenarios that are enabled in a pointing device environment include dynamically updateable targeted advertising. The general concept is illustrated in the block diagram of FIG. 9. As shown, a device 900 can point to a place, such as coffee shop 910, and discover the coffee shop as a point of interest along the directional line via pointing 905. Based on being pointed at and selected as a point of interest, coffee shop 910 can deliver static and/or dynamic content to the user, including a dynamically targeted advertisement, coupon, loyalty program, discount offer, etc. at 915 based on a host of factors and known user information.

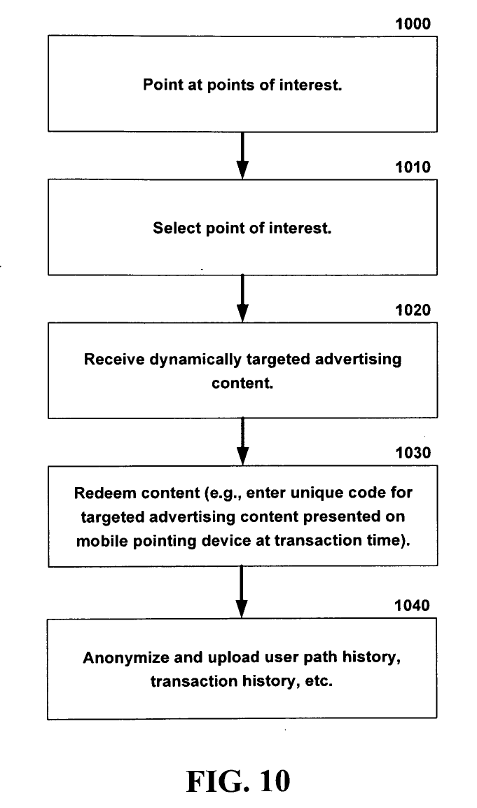

An exemplary process for realizing the targeted advertising by a mobile pointing device is shown in FIG. 10. At 100, a user points at a set of points of interest in one or more directions. At 1010, the user selects a point of interest, at which point at 1020, the device receives dynamically targeted advertising content. AT 1030, the advertising content can be redeemed by the user, e.g., a unique code for targeted advertising content can be presented on the mobile pointing device for use at transaction time. At 1040, the user's data can be anonymized and uploaded as user path history, transaction history, feedback history, etc.

For instance, by examining a user's path, the service may know that the user was recently looking for cars at a Ford dealership and then looking at a Chevy dealership. As a result, a competitive car maker could deliver an advertisement to the user that compares their car to other cars from Ford and Chevy the user likely saw that day. Or, for business and retail scenarios, a user may simply wonder “What is that place across the street? Let me point to it and find out.” At that time, the service can recognize the user's pointing device as a first time hit on that point of interest for the Cleaners across the street, and offer the first suit cleaning for free in order to entice the user of the device across the street, and into the store. However, the Cleaners can hardly afford to send a free cleaning to every user that points at the store. Thus, the next time the user points at the Cleaners, the service recognizes that it is the user's second trip to the Cleaners and thus only offer 10% off. A customer rewards/loyalty program can be run the same way, a running total reward or benefit can be displayed for the user as part of dynamic information shown to the user. In other words, not only is static information about the point of interest itself displayed, but something about the user's actual relationship history with the store can also be displayed dynamically, and updated when it changes. For instance, the last three purchases could be shown to the user when the user walks by and points at a gift shop.

In addition, the user might recognize that the store across the street has a name in Japanese that the user does not understand, in which case after pointing at the sign, the device can indicate “the store is actually a Japanese restaurant serving sushi.”

In addition, the store's menu, hours of operation and specials can be automatically localized in a language of choice. Transformation of language, where localized information exists, or auto-translation of language is another way that the information about a point of interest can be dynamically updated, e.g., from one language to another. Thus, auto-localization is an aspect of being able to tailor content to particular users. For instance, when in Korea, a non-Korean speaking English user may wish for point of interest information to auto-translate to English, or wish for the Korean and the English to be presented side by side to help learn Korean. Or, a Spanish user might buy a phone in US, but the user wants content in Spanish. One can see the opportunity to present localized information about points of interest pointed to by various international users is a beneficial feature for travel and other instances where language could be a barrier.

Advertisements can also be made to be time sensitive. For instance, a user might wish to discover about the restaurant across the street as part of a search or discovery scenario, and learn as a result that “happy hour is in 30 minutes and everything on the bar menu is half off regular price.” Moreover, after the user finishes a hearty happy hour, the user might rate the place or view others' ratings about the place to see what others are saying.

These are just some basic examples of what's possible when magnetic compasses, A-GPS, and accelerometers (optional for tilt and gestures) are combined along with a web service and store capable of serving up geo-tagged information such as reviews, annotations, ads and delivering chunks of POI data based on positioning and directional vector(s) of what the user is targeting with a pointing act with the device. This opportunity, while delivering significant value to consumers also has tremendous upside for businesses and enterprises, including, but not limited to, the following: (1) advertising and coupons are actually perceived to be valuable by consumers because they are of immediate potential due to proximity, (2) with search or discovery, the ads served up are highly targeted as they are for the business/attraction/location the that user actually selects or in which the user has otherwise expressed interest and (3) ads can be tailored to the precise user interacting with the system as the directional based web services have access to a pertinent set of user information, including usage patterns to enable scenarios like:

“The 19 year old male pointing at this café on Broadway is a first time ‘looker’ or ‘pointer’—present him with a ‘First Timer’ coupon good for a free bagel for stopping in with a purchase of coffee.”

“The lady pointing to the BMW dealership has also pointed to the Ford and Toyota dealerships this week—she's obviously car shopping but not at the high-end so provide her with an ad to entice her to test drive the 3-series.”

In addition, as noted for some of the scenarios above, ads are completely dynamic and controlled by the business owners, which, for instance, would allow a sushi restaurant to advertise a quick sale when business is slow to reduce the amount of spoiled fresh fish and drive impulse buys.

In this regard, the pointing based services know who the user is and how to broker communication with third parties and the user in the event that a transaction is to take place (“Contact Me”, “Remember this location”, etc.)—removing any need to have a pen, to take a picture, to remember something, etc. Also, to address privacy concerns, for user data that is not used directly on behalf of the user to target content to the user, an anonymizer can send back anonymized user data back into the ad engine to prevent identity theft, a fear of Big Brother, etc.

With dynamic advertising, advantageously, the system knows on your behalf and on behalf of points of interest in a user's history, whether the user has visited a particular point of interest before. This collective intelligence on the server side enables implementation of loyalty programs on the fly where it is warranted based on customer history.

Other scenarios, which are limitless, include “Time an advertisement for the start or conclusion of baseball game,” “First 100 customers of day get 50% off,” or “50% coupon for next 3 hours.” Since the advertising program or offer, or other dynamic content is in effect enforced by the service, a business owner need only specify dynamic policies for how to vary the advertising across demographics, times of day, frequency of visits, volume of sales to the user, etc., i.e., any variable that can change over time, space or context, can be the basis for dynamic advertisements.

In addition, the service makes the act of acquisition virtually non-existent. Unlike clipping coupons with scissors, a user merely points at a store, and automatically acquires the coupon for ready use in the store. Providing an automatic way to initiate an exchange of information alleviates the friction today between extracting information about a potential customer and providing information to the potential customer that he or she might want to know based on context, etc. Other business acts acquisition like receiving value added information from consumers, formerly difficult and time wasting, becomes easy to acquire. Any transaction cost in effect is reduced by these advertising scenarios since the user has in effect asked for information in a certain direction by pointing in that direction and asking for information, which initiates targeted content for that user. For instance, buying tickets, getting movie reviews from a review site, all such types of acts are facilitated on behalf of a user. In this respect, the service enables a platform for dynamically controlled content by the business owner to be delivered by consumers who have indicated some interest in the business owner by the act of pointing. Third party advertisements can also be delivered to the consumer as part of a pointing act based on information known about the user.

In sum, advertisements can be up to date, on demand and targeted to individuals based on their behavior. For instance, the first time an individual walks past a Starbucks and points, the Starbucks can serve and advertisement that says “Free bagel with coffee,” but then recognizing the same individual again the next day, might offer only “10% off drinks” and after the fifth time recognizing the individual, might offer only “5% off drinks.” For instance, a dynamic loyalty program can be offered for small businesses as part of a service, e.g., every 5th coffee free, etc., by tracking how rate or times users come to a particular location and/or make a purchase. Or inversely, when a previous customer has not visited in awhile, offering an attractive coupon to entice the customer back to the premises.

As a result, advertisements appear less like spam broadcast to the world or some particular user demographic, and behave more like added value (discount coupons, giveaways for stopping in, up-sell opportunities, etc.) since the value pertains to something at which the user is pointing.

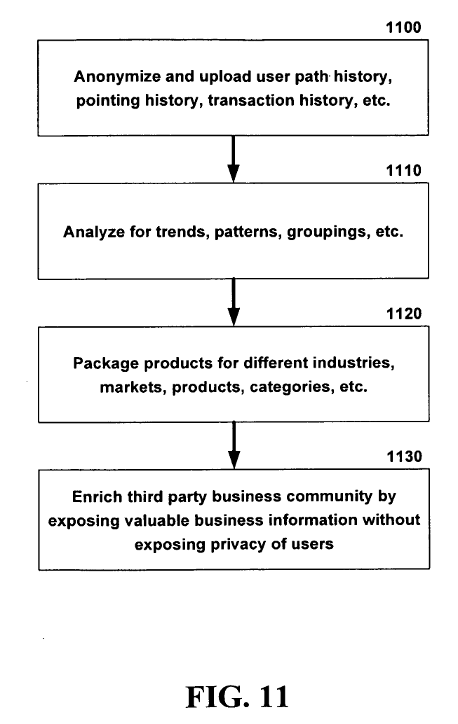

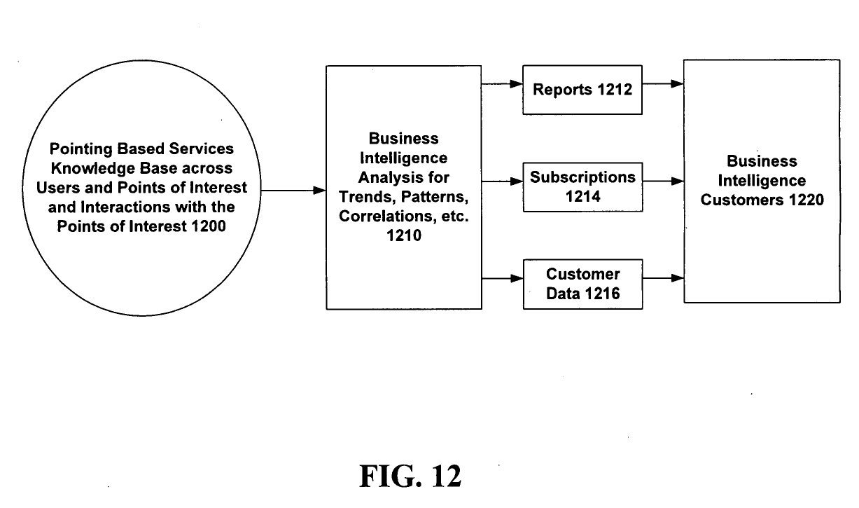

An exemplary business intelligence scenario built on pointing based services is illustrated in the flow diagram of FIG. 11 and also in the block diagram of FIG. 12. For instance, in FIG. 11, at 1100, user data such as user path history, pointing history, transaction history, etc. can be anonymized to the extent needed to protect privacy and uploaded to a centralized data store abstraction. At 1110, the aggregate user data is analyzed for trends, patterns, groupings, etc. At 1120, products are packaged for different industries (e.g., soft drink sales v. time data), markets (e.g., Philadelphia real estate interest v. time data), products (e.g., Starbucks coffee) and so on. At 1130, by delivering the BI to third parties, the entire business community is enriched and becomes more efficient.

In the block diagram of FIG. 12, starting with a knowledge base 1200 from the pointing based services, business intelligence analysis is performed to determine correlations, trends, patterns, etc. 1210. This results in reports 1212, subscriptions 1214, customer data 1216, etc., which can then be delivered to or subscribed to by customers 1220.

With processing power and business intelligence as part of the services back end, reporting services can be enabled for a host of parties that expose or show trends, etc., e.g., to business owners or to consumer protection agencies, or wherever relevant. For instance, a collection of database info across all Starbucks could be formed to help identify what makes one coffee shop stand out from the others based on outside pedestrian traffic. The services thus include a delivery mechanism, e.g., to subscribe for weekly monthly reports, view what other competitive business customers look like, determine what days/times are optimal for staying open in order to close during hours where no one walks past the business. Based on such information, new employee shift schedules could be formed with different overlap for high traffic times, effectively reducing the number of daily employees by 10%. In short, the number of ways to report business intelligence from the amount of data that could be made available is practically limitless.

Thus, with business intelligence scenarios, the service, or cloud, knows a lot of information, particularly over time, about what users look at, who they are, who they are not, etc. In essence, a user's life path information is stored in the cloud. If a 6-8 year old buys a lot of Iron Man comic books for a period of 3 years, 20 years later, if the same user walks near a store having a comic book with the first appearance of Iron Man, then the store can tailor an advertisement to that user based on the preference or nostalgia that other users are unlikely to have. The world is thus a garage sale, where the pointing device helps a user sift through and discard irrelevant junk, while helping the user to find rare treasure based on an intimate history with the user's path and transaction history.

Additionally, some scenarios predicated on speed and direction information can be realized with the pointing based services as described herein. For instance, based on a speed or velocity, it can be deduced that a device holder is driving. Thus, one scenario is to display reststops, gas stations, exits, etc. as points of interest rather than shoe boutiques, sidestreets off the highway, etc. which tend not to be relevant to a user's driving path, particularly when a user has already entered a destination. Similarly, walking can be distinguished from running, and similarly, biking or roller skating can be distinguished from walking. In such cases, i.e., in cases where something about the motion, speed or gesturing of the user indicates a unique activity, some assumptions can usually be made about what is irrelevant information.

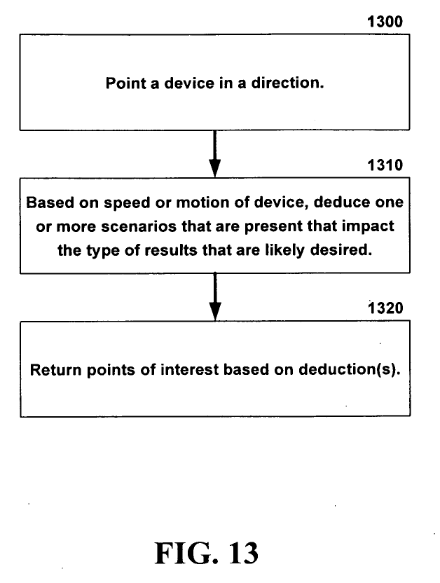

This is illustrated in FIG. 13 where at 1300, a user points with a pointed device. At 1310, the scope of points of interest is narrowed or widened, or otherwise filtered, based on a pattern exhibited with respect to motion, i.e., the filtering of possible points of interest can occur dynamically based on the speed or motions of a user that suggest various circumstances, by implication, which the user can override if need be. Then, at 1320, the service automatically returns endpoints for user viewing based on the assumptions made at 1310.

With respect to definition of scope of points of interest, in one embodiment, a frustum is used to define the points of interest within scope, i.e., if a point of interest is within the frustum, the point of interest is within scope. In one embodiment, a pyramid frustum is defined. In another, an ovular or cone shape can define the frustum. In one embodiment that minimizes potential user experience issues, a rectangular viewing frustum is used. In addition, in one embodiment, based on the density of the POIs in a given tile (representation of chunks of POIs delivered to devices), the visibility of the frustum can be expanded or shrunk so that the user interface is not overwhelmed with too much information or underwhelmed with too little information. For instance, extending or retracting the frustum can achieved by modifying the far plane, or by expanding the width or height of the frustum. In another embodiment, POIs are categorized by types (or any hierarchy) into slabs, which the user can expand to see, for example, all the food options in the current view, all the bars, etc.

Another scenario that can be realized is to find the closest set of landmarks by how long it actually takes (e.g., factoring in winding roads and actual time it has taken in the past by other users) as opposed to actual distance as the shortest distance between two points A and B as the crow flies. The path information made available to the cloud services and storage from a large number of users can form the basis for powerful algorithms that can average over time of day and other factors to provide an accurate view to the user of how long it will actually take to get to landmark A as opposed to landmark B. For instance, landmark A may be closer by distance, but longer according to mean traffic patterns.

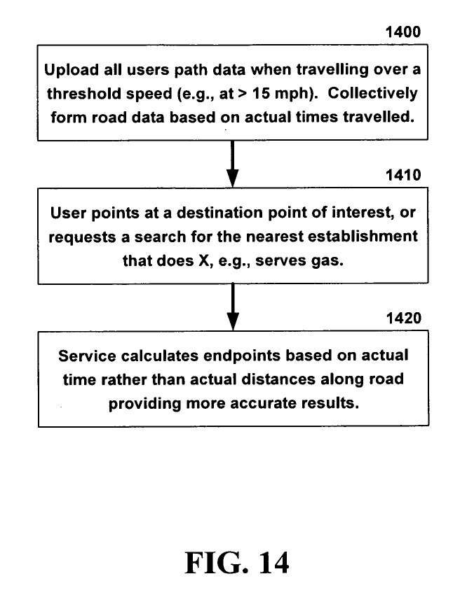

This is illustrated in the flow diagram of FIG. 14. At 1400, users' path data when travelling over a threshold speed (e.g., at >15 mph) can be uploaded and aggregated thereby collectively forming road data based on actual times traveled by actual users. At 1410, a user points at a destination point of interest, or requests a search for the nearest establishment that does X, e.g., serves gas. At 1420, the service calculates endpoints based on actual time rather than actual distances along road providing more accurate results.

A variety of scenarios can also be realized around real estate with pointing based services. For instance, suppose a user wishes to rent an apartment in a new city in a particular neighborhood. It would be great if that user could simply walk down the streets of the particular neighborhood, and point around at real estate and be shown potential rental opportunities as points of interest on a map. Or, where a user would like to communicate with an owner of a piece of real estate with an informal above market purchase or rental price, the user could message the owner via the point of interest. The transaction cost of starting a conversation that the seller does not want to engage in goes away. The seller could have a simple rule that states reject all communications that do not offer 200% of the market value. A conversation that should never happen is thus averted. However, where an eager buyer places a premium on the location for some other reason and is willing to buy the property at 200%, the seller has lost nothing by learning of this, and a transaction is facilitated with contact made available/possible through the service without necessarily sharing the buyer's name, until the buyer wishes to move forward with a potential transaction.

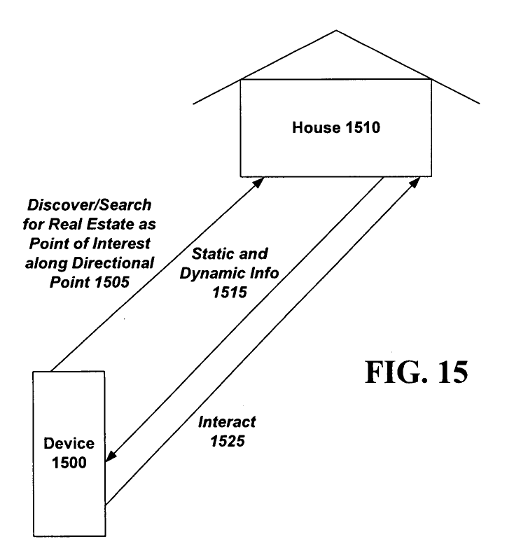

A general block diagram is illustrated in FIG. 15, and shows that the pointing device services can be focused on any industry, whether real estate, locating paint stores, or finding cruise ships. In FIG. 15, a pointing device 1500 can be pointed generally at real estate 1510 at 1505. Then, static and/or dynamic information can be provided from real estate 1510 back to device 1500 at 1515. At that point, the user can choose to interact with the real estate based on available options at 1525, e.g., “contact me to discuss a sale.”

Such a system could work whether it is for rental properties, commercial properties, 3 bedrooms, view property, square footage, etc., i.e., all of the traditional ways of filtering on properties can also be performed to reduce the number of potential hits to the ones preferred by the user. In a nutshell, a user can point at real estate, get information about it by pointing, and for available apartments, the user can instantly contact the owner and ask for a showing, or close sight unseen. A user or owner might see that the pool in the backyard is not listed with the point of interest information, and add it to the list of notes for that property. These features can be verified or unverified, but in either case, a mobile Wikipedia scenario for particular pieces of real estate can be started for a variety of purposes.

For another exemplary real estate scenario, a user happens to see an open house for a historical property for sale. Rather than trying to set up in person meeting with the seller's agent, the user can simply input “contact me” with the pointing device, such that the third party is automatically provided with your contact information, eliminating any need to find a pen, take a card, enter a registration process, etc., which are not spontaneous enough acts to actually get contacted.

Some other real estate scenarios that may be realized include:

(1) A user sees a couple of houses for sale along my walk to work. Rather than needing to stop by to see in person, the user looks at inside pictures and learns when the houses were built and that George Washington slept in one of the houses in 1775;

(2) The user actually likes one of the houses but does not have time to follow up and wishes to think about it some in the meantime. The user thus notes the house for follow up. As part of follow up, when the user arrives at work, the user enters the pointing based services from a PC via high speed Internet connection, and follows up with two paragraphs of questions about the house that are automatically sent to the owner. No messy typing on a tiny mobile keyboard, or remembering the contact information is necessary;

(3) A user observes on a sign in a window that there is a lease special on a couple of units, but the management offices are closed that day. The user activates the “Contact Me” control and the management office calls the user back on Tuesday when open again—one way this can work is leveraging that the service knows where the user is and what they're pointing to, therefore the service can broker communications (such as name, phone number, user's email, etc.) on behalf of the client and the POI without additional authentication or transaction cost; and

(4) on the property owner's side, the property owner can customize content for high net worth individuals by advertising “Free bottle of Dom Perignon for stopping in at the open house or for a virtual tour of the property for sale/rent.”

Other scenarios that can be enabled for pointing based services are various scenarios that take tilt of the device into account as well as compass directions. For instance, with a device that can determine tilt, one scenario that can be realized is what is on the second floor or 10^{th} floor by pointing upwards at a building. Or, after a user designates a building, the UI could request that the user point at a floor, or a span of floors.

Another scenario can be realized for pointing devices with a camera that captures in the pointing direction whereby points of interest and associated static and/or dynamic information can be overlaid on the image being acquired by the camera. Intuitively, the user sees what is being pointed at, e.g., business in the empire state building, listed 10 floors at a time. Or, another scenario is deducing that someone on the 1st floor pointing at a coffee shop across the street probably means to point at the coffee shop, whereas a user from the top of a building pointing down towards the coffee shop, may mean to learn of the road or building name instead, due to the granularity of information likely to be sought in connection with the relative altitudes of the user.

With respect to scenarios that factor in timing into the delivery of information via location based services, such information can be time dependent from either the consumer or store owner side. For just one of many examples, during happy hour, the information broadcast by a restaurant may include a happy hour menu, but not at other times, whereas from the consumer side, at 6 pm, restaurants may be relevant to the consumer, but not at midnight when the restaurant is closed. Thus, time based criteria benefit everyone in the ecosystem by allowing businesses and users to be more adaptive.

Another scenario could be in the emergency services department. Get me to the nearest public phone, give me a police bureau and ask them to hurry to my location at the click of a button designating the police bureau, give me closest hospital, etc.

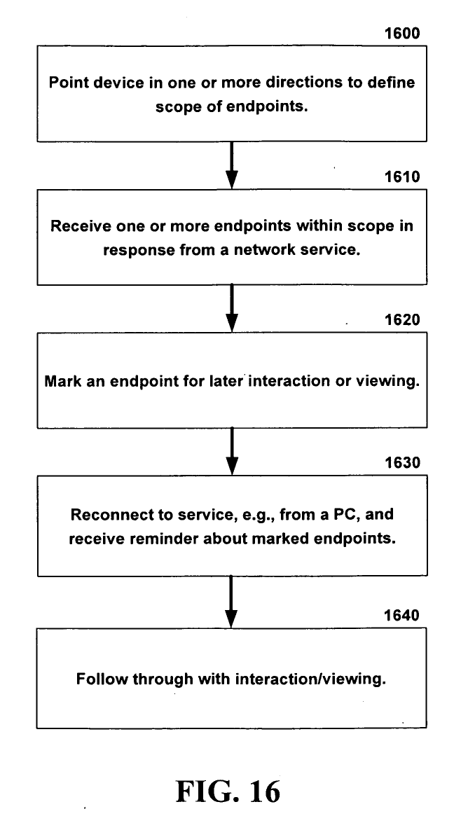

As mentioned in connection with real estate scenarios, a delayed typing scenario can be realized for any scenario. For instance, typing on a mobile device can be inconvenient. Thus, via the service, a user can point at a point of interest, and mark the point of interest for later action. Thus, when the user reaches a PC, a reminder to interact with the point of interest is present and the user can type with a full keyboard. This is illustrated in the flow chart of FIG. 16.

At 1600, a user points a pointer device in one or more directions to define scope of endpoints. At 1610, the user receives an indication of one or more endpoints within scope in response from a network service. At 1620, the user marks endpoint(s) for later interaction or viewing. At 1630, when the user reconnects to the service, e.g., from a PC, the user can receive reminders about marked endpoints and follow through with interaction/viewing at 1640, as desired.

Some algorithmic scenarios that may be realized by any of the above described services include interpreting different margins of error with different compensation for different instruments. For instance, the intersection algorithm possesses different resolution with GPS v. A-GPS v. E-GPS, and accordingly, algorithms for distinguishing among boundary boxes can normalize the results to obtain the same or similar set of points of interest for the same or similar pointing action.

### Supplemental Context Re: Pointing Device Scenarios

With respect to a representative set of user settings, a number or maximum number of desired endpoints delivered as results can be configured. How to filter can also be configured, e.g., 5 most likely, 5 closest, 5 closest to 100 feet away, 5 within category or sub-category, alphabetical order, etc. In each case, based on a pointing direction, implicitly a cone or other cross section across physical space is defined as a scope of possible points of interest. In this regard, the width or deepness of this cone or cross section can be configurable by the user to control the accuracy of the pointing, e.g., narrow or wide radius of points and how far out to search.

To support processing of vector information and aggregating POI databases from third parties, a variety of storage techniques, such as relational storage techniques can be used. For instance, Virtual Earth data can be used for mapping and aggregation of POI data can occur from third parties such as Tele Atlas, NavTeq, etc. In this regard, businesses not in the POI database will want to be discovered and thus, the service provides a similar, but far superior from a spatial relevance standpoint, Yellow Pages experiences where businesses will desire to have their additional information, such as menus, price sheets, coupons, pictures, virtual tours, etc. accessible via the system.

In addition, a synchronization platform or framework can keep the roaming caches in sync, thereby capturing what users are looking at and efficiently processing changes. Or, where a user goes offline, local changes can be recorded, and when the user goes back online, such local changes can be synchronized to the network or service store. Also, since the users are in effect pulling information they care about in the here and in the now through the act of pointing with the device, the system generates high cost per thousand impression (CPM) rates as compared to other forms of demographic targeting. Moreover, the system drives impulse buys, since the user may not be physically present in a store, but the user may be near the object, and by being nearby and pointing at the store, information about a sale concerning the object can be sent to the user.

As mentioned, different location subsystems, such as tower triangulation, GPS, A-GPS, E-GPS, etc. have different tolerances. For instance, with GPS, tolerances can be achieved to about 10 meters. With A-GPS, tolerances can be tightened to about 12 feet. In turn, with E-GPS, tolerance may be a different error margin still. Compensating for the different tolerances is part of the interpretation engine for determining intersection of a pointing vector and a set of points of interest. In addition, as shown in FIGS. 4-6, a distance to project out the pointing vector can be explicit, configurable, contextual, etc.

In this regard, the various embodiments described herein can employ any algorithm for distinguishing among boundaries of the endpoints, such as boundary boxes, or rectangles, triangles, circles, etc. including 3-D counterpart shapes, such as spheres, cubes, tetrahedrons, etc. As a default radius, e.g., 150 feet could be selected, and such value can be configured or be context sensitive to the service provided. On-line real estate sites can be leveraged for existing POI information. Since different POI databases may track different information at different granularities, a way of normalizing the POI data according to one convention or standard can also be implemented so that the residential real estate location data of Zillow can be integrated with GPS information from Starbucks of all the Starbucks by country.

In addition, similar techniques can be implemented in a moving vehicle client that includes GPS, compass, accelerometer, etc. By filtering based on scenarios (e.g., I need gas), different subsets of points of interest (e.g., gas stations) can be determined for the user based not only on distance, but actual time it may take to get to the point of interest. In this regard, while a gas station may be 100 yards to the right off the highway, the car may have already passed the corresponding exit, and thus more useful information to provide is what gas station will take the least amount of time to drive from a current location based on direction/location so as to provide predictive points of interest that are up ahead on the road, and not already aged points of interest that would require turning around from one's destination in order to get to them.

For existing motor vehicle navigation devices, or other conventional portable GPS navigation devices, where a device does not natively include directional means such as a compass, the device can have an extension slot that accommodates direction information from an external directional device, such as a compass. Similarly, for laptops or other portable electronic devices, such devices can be outfitted with a card or board with a slot for a compass. While any of the services described herein can make web service calls as part of the pointing and retrieval of endpoint process, as mentioned, one advantageous feature of a user's locality in real space is that it is inherently more limited than a general Internet search for information. As a result, a limited amount of data can be predictively maintained on a user's device in cache memory and properly aged out as data becomes stale.

Any device can include the embodiments described herein, including MP3 players, such as a Zune device, GPS navigation devices, bike computers, sunglass/visor systems, motor vehicles, mobile phones, laptops, PDA, etc.

One way to obtain the service applications, assuming the underlying measuring instruments to participate in the real-time gathering of directional information, is to message to a service to obtain the application, e.g., by text messaging to service, or getting a client download link. Another vehicle for enabling the service is to provide it natively in the operating system or applications of a mobile devices. Since a hardware abstraction layer accommodates different methods for collecting position, direction, acceleration information, the same platform can be used on any device regardless of the precise underlying hardware.

In another aspect of any of the embodiments described herein, because stateless messaging is employed, if communications drop with one network, the device can begin further communicating via another network. For instance, a device has two channels, and a user gets on a bus, but no longer have GPRS or GPS activity. Nonetheless the user is able to get the information the device needs from some other channel. Just because a tower, or satellites are down, does not mean that the device cannot connect through an alternative channel, e.g., the bus's GPS location information via Bluetooth.

With respect to exemplary mobile client architectures, a representative device can include, as described variously herein, client Side Storage for housing and providing fast access to cached POI data in the current region including associated dynamically updated or static information, such as annotations, coupons from businesses, etc. This includes usage data tracking and storage. In addition, regional data can be a cached subset of the larger service data, always updated based on the region in which the client is roaming. For instance, POI data could include as a non-limiting example, the following information:

| | |
|---|---|
| POI coordinates and data | //{−70.26322, 43.65412, |
| “STARBUCK'S”} | |
| Localized annotations | //Menu, prices, hours of operation, etc |
| Coupons and ads | //Classes of coupons (new user, |
| returning, etc) | |

Support for different kinds of information (e.g., blob v structured information (blob for storage and media; structured for tags, annotations, etc.)

A device can also include usage data and preferences to hold settings as well as usage data such as coupons “activated,” waypoints, businesses encountered per day, other users encountered, etc. to be analyzed by the cloud services for business intelligence analysis and reporting.

A device can also include a continuous update mechanism, which is a service that maintains the client's cached copy of a current region updated with the latest. Among other ways, this can be achieved with a ping-to-pull model that pre-fetches and swaps out the client's cached region using travel direction and speed to facilitate roaming among different regions. This is effectively a paging mechanism for upcoming POIs. This also includes sending a new or modified POI for the region (with annotations+coupons), sending a new or modified annotation for the POIs (with coupons), or sending a new or modified coupon for the POI.

### Exemplary Portable Pointing Devices

The scenarios for portable pointing devices are predicated on a device that can be pointed at objects by a user. Accordingly, for context for such pointing devices, in various embodiments, a portable electronic device includes a positional component for receiving positional information as a function of a location of the portable electronic device and a directional component that outputs direction information as a function of an orientation of the portable electronic device. A location based engine also processes the positional information and the direction information to determine a subset of points of interest relative to the portable electronic device as a function of at least the positional information and the direction information.

Accordingly, in various non-limiting embodiments, mobile computing devices can include solid state or magnetic compasses, which allow users to point their handsets to a location of interest, instead of engaging in a conventional search, and gain synchronized information about a location from an owner of the endpoint, one or more third parties, or a web service, such as a mapping service.

As described in more detail below, leveraging digital compasses and GPS to provide direction and location information enables a next-generation of location based search services, discoverability services and mobile gaming services, where the digital compass and GPS can be used as a pointing device. Using a digital compass, e.g., solid state, magnetic, sun/moon based, etc. on a mobile endpoint facilitates point and upload scenarios, point and synchronize geographical information to a Web service, cloud services or another endpoint.

The positional component can be a positional GPS component for receiving GPS data as the positional information. The directional component can be a magnetic compass and/or a gyroscopic compass that outputs the direction information. The device can include acceleration component(s), such as accelerometer(s), that outputs acceleration information associated with movement of the portable electronic device. A separate sensor can also be used to further compensate for tilt and altitude adjustment calculations.

In one embodiment, the device includes a cache memory for dynamically storing a subset of endpoints of interest that are relevant to the portable electronic device and at least one interface to a network service for transmitting the positional information and the direction information to the network service. In return, based on real-time changes to the positional information and direction/pointing information, the device dynamically receives in the cache memory an updated subset of endpoints that are potentially relevant to the portable electronic device.

For instance, the subset of endpoints can be updated as a function of endpoints of interest within a pre-defined distance substantially along a vector defined by the orientation of the portable electronic device. Alternatively or in addition, the subset of endpoints can be updated as a function of endpoints of interest relevant to a current context of the portable electronic device. In this regard, the device can include a set of Representational State Transfer (REST)-based application programming interfaces (APIs), or other stateless set of APIs, so that the device can communicate with the service over different networks, e.g., Wi-Fi, a GPRS network, etc. or communicate with other users of the service, e.g., Bluetooth. For the avoidance of doubt, the embodiments are in no way limited to a REST based implementation, but rather any other state or stateful protocol could be used to obtain information from the service to the devices, e.g., simple object access protocol (SOAP).

The directional component outputs direction information including compass information based on calibrated and compensated heading/directionality information. The directional component can also include direction information indicating upward or downward tilt information associated with a current upward or downward tilt of the portable electronic device, so that the services can detect when a user is pointing upwards or downwards with the device in addition to a certain direction. The height of the device itself can also be taken into account to distinguish between an event of pointing with a device from the top of a building (likely pointing to other buildings, bridges, landmarks, etc.) and the same event from the bottom of the building (likely pointing to a shop at ground level). One can also use a 3-axis magnetic field sensor to implement a compass to obtain tilt readings.

In this respect, a gesturing component can also be included in the device to determine a current gesture of a user of the portable electronic device from a set of pre-defined gestures. For instance, gestures can include zoom in, zoom out, panning to define an arc, all to help filter over potential subsets of points of interest for the user.

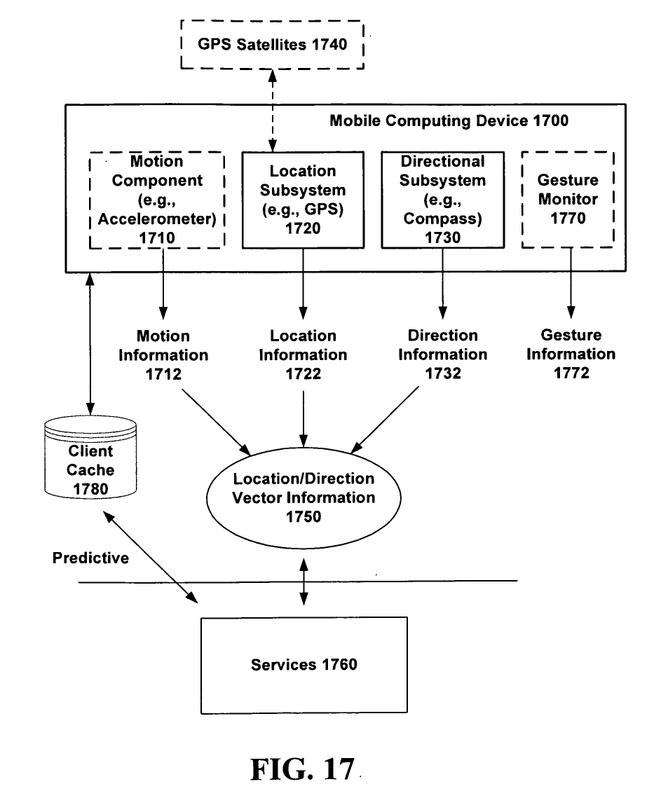

For instance, FIG. 17 illustrates a mobile computing device 1700 according to an embodiment. In this regard, a set of services 1760 can be built based on location information 1722 and direction information 1732 collected by the phone. For instance, location information 1722 can be recorded by a location subsystem 1720 such as a GPS subsystem communicating with GPS satellites 1740. Direction or pointing information 1732 can be collected by a direction subsystem 1730, such as a compass, e.g., gyroscopic, magnetic, digital compass, etc. In addition, optionally, movement information 1712 can be gathered by the device 1700, e.g., via tower triangulation algorithms, and/or acceleration of the device 1700 can be measured as well, e.g., with an accelerometer. The collective information 1750 can be used to gain a sense of not only where the device 1700 is located in relation to other potential points of interest tracked or known by the overall set of services 1760, but also what direction the user is pointing the device 1700, so that the services 1760 can appreciate at whom or what the user is pointing the device 1700.

In addition, a gesture subsystem 1770 can optionally be included, which can be predicated on any one or more of the motion information 1712, location information 1722 or direction information 1732. In this regard, not only can direction information 1732 and location information 1722 be used to define a set of unique gestures, but also motion information 1712 can be used to define an even more complicated set of gestures.

In one embodiment, information is predictively stored/updated in a local cache of the user/device, so that information about endpoints of potential interest to a user's present position and path is already available on the device by the time the information is of interest.

Thus, a device 1700 can include a client side cache 1780 of potentially relevant points of interest, which, based on the user's movement history can be dynamically updated. The context, such as geography, speed, etc. of the user can be factored in when updating. For instance, if a user's velocity is 2 miles an hour, they may be walking and interested in updates at a city block by city block level, or at a lower level granularity if they are walking in the countryside. Similarly, if a user is moving on a highway at 60 miles per hour, the block-by-block updates of information are no longer desirable, but rather a granularity can be provided and predictively cached on the device 1700 that makes sense for the speed of the vehicle.

In various alternative embodiments, gyroscopic or magnetic compasses can provide directional information. A REST based architecture enables data communications to occur over different networks, such as Wi-Fi and GPRS architectures. REST based APIs can be used, though any stateless messaging can be used that does not require a long keep alive for communicated data/messages. This way, since networks can go down with GPRS antennae, seamless switching can occur to Wi-Fi or Bluetooth networks to continue according to the pointing based services enabled by the embodiments described herein. The device includes a file system to interact with a local cache, store updates for synchronization to the service, exchange information by Bluetooth with other users of the service, etc. Accordingly, operating from a local cache, at least the data in the local cache is still relevant at a time of disconnected, the user can still interact with the data, and finally synchronize according to any updates made when re-connected to the network, or to another device that has more up to date GPS data, POI data, etc. In this regard, a switching architecture is adopted for the device to perform a quick transition from connectivity from one networked system (e.g., cell phone towers) to another computer network (e.g., Wi-Fi) to a local network (e.g., mesh network of Bluetooth connected devices).

With respect to user input, a set of soft keys, touch keys, etc. can be provided to facilitate in the directional-based pointing services provided herein. A device can include a windowing stack in order to overlay different windows, or provide different windows of information regarding a point of interest (e.g., hours and phone number window versus interactive customer feedback window). Audio can be rendered or handled as input by the device. For instance, voice input can be handled by the service to explicitly point without the need for a physical movement of the device. For instance, a user could say into a device “what is this building to my right?” and have the device transmit current direction/movement information to a service, which in turn intelligently determines what the building to the right of the user is, and returns a host of relevant information about the building.

In this respect, a device can include a variety of spatial and map components and intelligence to determine intersections for directional arcs. For instance, objects of interest could be represented with exact boundaries, approximated with spheres, subshells (stores in a mall) of a greater shell (mall), hierarchically arranged, etc. Dynamically generated bounding boxes can also be implemented work, i.e., any technique can be used to obtain boundary information for use in an intersection algorithm. Thus, such boundaries can be implicitly or explicitly defined for the POIs. Thus, the device includes an intersection component that interprets pointing information relative to a set of potential points of interest. The engine can perform such intersections knowing what the resolutions of the measuring instruments are on the device, such as the resolution of a GPS system.

Such techniques can include taking into account how far a user is from a potential point of interest, the size of the point of interest and how that is defined, as well as the resolution of location instrumentation, such as the GPS system. The device can also optionally include an altimeter, or any other device that gives altitude information. The altitude information can supplement existing location information for certain specialized services where points of interest vary significantly at different altitudes. It is noted that GPS itself has some information about altitude in its encoding.

### Exemplary Networked and Distributed Environments

One of ordinary skill in the art can appreciate that the various embodiments of methods and devices for pointing based services and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

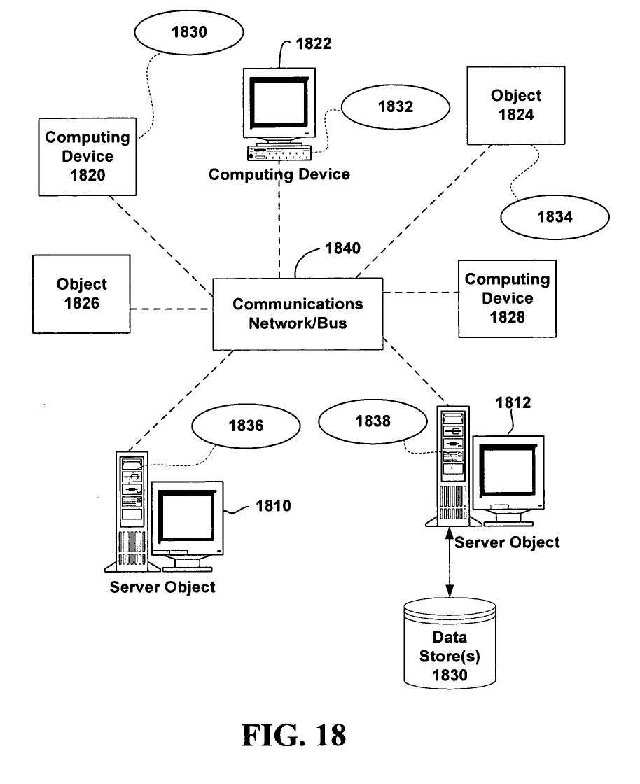

FIG. 18 provides a non-limiting schematic diagram of an exemplary networked or distributed computing environment. The distributed computing environment comprises computing objects 1810, 1812, etc. and computing objects or devices 1820, 1822, 1824, 1826, 1828, etc., which may include programs, methods, data stores, programmable logic, etc., as represented by applications 1830, 1832, 1834, 1836, 1838. It can be appreciated that objects 1810, 1812, etc. and computing objects or devices 1820, 1822, 1824, 1826, 1828, etc. may comprise different devices, such as PDAs, audio/video devices, mobile phones, MP3 players, laptops, etc.

Each object 1810, 1812, etc. and computing objects or devices 1820, 1822, 1824, 1826, 1828, etc. can communicate with one or more other objects 1810, 1812, etc. and computing objects or devices 1820, 1822, 1824, 1826, 1828, etc. by way of the communications network 1840, either directly or indirectly. Even though illustrated as a single element in FIG. 18, network 1840 may comprise other computing objects and computing devices that provide services to the system of FIG. 18, and/or may represent multiple interconnected networks, which are not shown. Each object 1810, 1812, etc. or 1820, 1822, 1824, 1826, 1828, etc. can also contain an application, such as applications 1830, 1832, 1834, 1836, 1838, that might make use of an API, or other object, software, firmware and/or hardware, suitable for communication with or implementation of the user profiling in a transaction and advertising platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 18, as a non-limiting example, computers 1820, 1822, 1824, 1826, 1828, etc. can be thought of as clients and computers 1810, 1812, etc. can be thought of as servers where servers 1810, 1812, etc. provide data services, such as receiving data from client computers 1820, 1822, 1824, 1826, 1828, etc., storing of data, processing of data, transmitting data to client computers 1820, 1822, 1824, 1826, 1828, etc., although any computer can be considered a client, a server, or both, depending on the circumstances. Any of these computing devices may be processing data, or requesting services or tasks that may implicate the improved user profiling and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1840 is the Internet, for example, the servers 1810, 1812, etc. can be Web servers with which the clients 1820, 1822, 1824, 1826, 1828, etc. communicate via any of a number of known protocols, such as the hypertext transfer protocol (HTTP). Servers 1810, 1812, etc. may also serve as clients 1820, 1822, 1824, 1826, 1828, etc., as may be characteristic of a distributed computing environment.

### Exemplary Computing Device

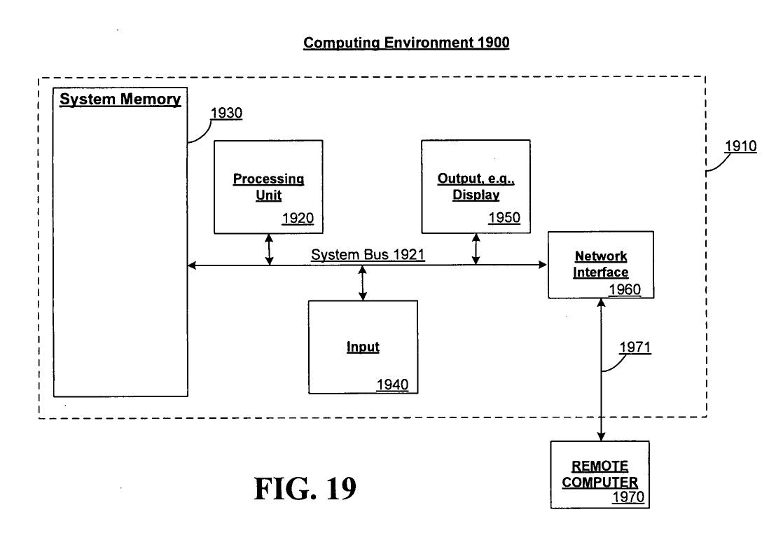

As mentioned, various embodiments described herein apply to any device wherein it may be desirable to perform pointing based services. It should be understood, therefore, that handheld, portable and other computing devices and computing objects of all kinds are contemplated for use in connection with the various embodiments described herein, i.e., anywhere that a device may request pointing based services. Accordingly, the below general purpose remote computer described below in FIG. 19 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer-executable instructions, such as program modules, being executed by one or more computers, such as client workstations, servers or other devices. Those skilled in the art will appreciate that network interactions may be practiced with a variety of computer system configurations and protocols.

FIG. 19 thus illustrates an example of a suitable computing system environment 1900 in which one or more of the embodiments may be implemented, although as made clear above, the computing system environment 1900 is only one example of a suitable computing environment and is not intended to suggest any limitation as to the scope of use or functionality of any of the embodiments. Neither should the computing environment 1900 be interpreted as having any dependency or requirement relating to any one or combination of components illustrated in the exemplary operating environment 1900.

With reference to FIG. 19, an exemplary remote device for implementing one or more embodiments herein can include a general purpose computing device in the form of a handheld computer 1910. Components of handheld computer 1910 may include, but are not limited to, a processing unit 1920, a system memory 1930, and a system bus 1921 that couples various system components including the system memory to the processing unit 1920.

Computer 1910 typically includes a variety of computer readable media and can be any available media that can be accessed by computer 1910. The system memory 1930 may include computer storage media in the form of volatile and/or nonvolatile memory such as read only memory (ROM) and/or random access memory (RAM). By way of example, and not limitation, memory 1930 may also include an operating system, application programs, other program modules, and program data.

A user may enter commands and information into the computer 1910 through input devices 1940 A monitor or other type of display device is also connected to the system bus 1921 via an interface, such as output interface 1950. In addition to a monitor, computers may also include other peripheral output devices such as speakers and a printer, which may be connected through output interface 1950.

The computer 1910 may operate in a networked or distributed environment using logical connections to one or more other remote computers, such as remote computer 1970. The remote computer 1970 may be a personal computer, a server, a router, a network PC, a peer device or other common network node, or any other remote media consumption or transmission device, and may include any or all of the elements described above relative to the computer 1910. The logical connections depicted in FIG. 19 include a network 1971, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to derive information about surrounding points of interest.

There are multiple ways of implementing one or more of the embodiments described herein, e.g., an appropriate API, tool kit, driver code, operating system, control, standalone or downloadable software object, etc. which enables applications and services to use the pointing based services. Embodiments may be contemplated from the standpoint of an API (or other software object), as well as from a software or hardware object that provides pointing platform services in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists. Similarly, where a method is practiced, a corresponding device can be provided that practices that method via one or more components.

While the various embodiments have been described in connection with the preferred embodiments of the various figures, it is to be understood that other similar embodiments may be used or modifications and additions may be made to the described embodiment for performing the same function without deviating therefrom. Still further, one or more aspects of the above described embodiments may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method, comprising:
receiving direction information associated with at least one direction of a device;
identifying points of interest that substantially intersect with the at least one direction according to an intersection determination; and
displaying static and dynamic information associated with at least one point of interest of the points of interest.

2. The method of claim 1, further comprising:
receiving input relating to the dynamic information including input regarding a message to be sent to the at least one point of interest or input identifying at least one change to be made to the dynamic information.

3. The method of claim 2, further comprising:
synchronizing the message or the at least one change to a network service in response to the interacting.

4. The method of claim 1, wherein the receiving includes receiving at least one filter criteria for filtering the points of interest in addition to the intersection determination.

5. A method for receiving dynamically determined content from a pointer based service by a pointer device, comprising:
receiving direction information associated with at least one direction of the device;
identifying at least one point of interest that is substantially within a scope defined by the at least one direction of the device; and
receiving dynamically generated content from the at least one point of interest by the device based on a characteristic of a relationship between the device and the at least one point of interest.

6. The method of claim 5, wherein the receiving includes receiving a dynamically generated advertisement from the at least one point of interest.

7. The method of claim 5, wherein the receiving includes receiving a dynamically generated coupon from the at least one point of interest.

8. The method of claim 5, wherein the receiving includes receiving dynamically generated content about a loyalty program applicable to the device based on its history.

9. The method of claim 5, further comprising redeeming the dynamic content at the at least one point of interest and realizing a corresponding value of the dynamic content by presenting a validation code included in the dynamically generated content.

11. A method for reporting over aggregate data from pointer based services using business intelligence processes, comprising:
receiving user path information and past interaction with points of interest information from pointer based services enabled devices to form aggregate user data;
performing at least one business intelligence process over the aggregate user data to determine at least one statistically significant correlation; and
automatically generating a report based on the at least one statistically significant correlation.

12. The method of claim 11, further comprising:
anonymizing the user path information and past interaction with points of interest information.

13. A device provisioned for pointing based services, comprising:
a direction component that determines direction information associated with at least one pointed to direction of the device and identifies points of interest that are substantially within boundaries set by the at least one direction according to a boundary test; and
a filter component that filters the points of interest to identify at least one point of interest of the points of interest as a function of a state or parameter of the device.

14. The device of claim 13, wherein the filter component filters the points of interest to identify at least one point of interest based on an analysis of a speed of the device.

15. The device of claim 14, wherein the filter component filters the points of interest to identify at least one point of interest based on an analysis of a current speed of the device.

16. The device of claim 14, wherein the filter component filters the points of interest to identify at least one point of interest based on an analysis of a recent speed of the device.

17. The device of claim 13, wherein the filter component filters the points of interest to identify at least one point of interest based on an analysis of an acceleration of the device.

18. The device of claim 13, wherein the direction component identifies a real estate point of interest according to a line of sight algorithm implemented as a function of the direction information.

19. The device of claim 18, further comprising:
an input analysis component that automatically requests an owner of the real estate point of interest to initiate contact by automatically providing the contact details of the user to the owner.

20. The device of claim 13, wherein the filter component collects user path data when path of travel information and speed information of the device indicate travel in a motor vehicle to form collective user path data and displays path information to the user based on the collective user path data according to a time based analysis according to how long paths have historically taken for a given time of day.
